(19) United States
(12) Patent Application Publication
(10) Pub. No.: US 2022/0123620 A1
(43) Pub. Date: Apr. 21, 2022

(54) PUMP WITH A WIRE POSITIONING PLATE

(71) Applicant: XYLEM EUROPE GMBH, Schaffhausen (CH)

(72) Inventors: Stefano DANIELI, Valdagno (IT); Luigi D'ANDREA, Thiene (IT)

(21) Appl. No.: 17/429,552

(22) PCT Filed: Jan. 31, 2020
(86) PCT No.: PCT/EP2020/052418

§ 371 Date: Aug. 9, 2021

(30) Foreign Application Priority Data
Feb. 14, 2019 (EP) 19157109.0

(51) Int. Cl. H02K 5/04; H02K 1/12; F04D 25/06

(52) U.S. Cl. CPC H02K 5/04; F04D 25/0693; H02K 1/12

(57) ABSTRACT

A pump includes an electric motor having a stator assembly. The stator assembly has a wire positioning plate supporting electrical connections for electrical contact with at least one lead wire, wherein wire guides extend vertically from the wire positioning plate, each wire guide having at least one guide path for supporting wire portions of the at least one lead wire over the wire positioning plate wherein the guide paths are vertically arranged relative to the wire positioning plate such that an overlapping wire portion is vertically spaced from a corresponding supported wire portion.

### TECHNICAL FIELD

This disclosure generally relates to the pumps with electrical motors and in particular to pumps with electrical motors having stator assemblies provided with wire connection plates.

### BACKGROUND

A pump may generally be driven by an electric motor. The electric motor has a stator assembly that usually comprises a core onto which winding carriers are mounted. A plurality of stator windings are wound around the winding carriers. A wire connection plate may be disposed on one of the axial ends, on which electrical connection elements or contact elements are provided for the connection of a single lead wire or a plurality of lead wires. The single or plurality of lead wires are guided to the contact elements for connection thereto. The single or plurality of lead wires may be disposed at different circumferential positions in relation to the locations of the winding coils. Insulation problems may occur at contact points between portions of the lead wire or between portions of the plurality of lead wires. The voltage difference at these contact points of the lead wire or of the plurality of lead wires may result in sparking.

U.S. Pat. No. 8,179,003 discloses a motor with a wire fixing plate having a stator core, a stator winding, a lead wire. The wire fixing plate has multiple fixed portions. The wire fixing plate is made of insulating plastics, and the lead wire is fixed on the wire fixing plate via the fixed portions. The motor features firm fixation and good insulating property of a lead wire by way of grooves and pressing buckles.

EP0993095 discloses a stator having a stator plate packet with stator windings, and a cross-wiring arrangement for cross-connection of the stator winding wires to electrical connecting leads. Insulating end plates are formed on the ends of the stator plate packet. The cross-connection arrangement has at least one multiple contact chamber. This is formed by sub-chambers that are adjacent to a cross-connection plate, in the mounted state, and accommodate a common contact element connecting the sub-chambers.

The present disclosure is directed, at least in part, to improving or overcoming one or more aspects of the prior art system.

### BRIEF SUMMARY

The present disclosure describes a pump comprising an electric motor having a stator assembly. The stator assembly comprises a wire positioning plate supporting electrical connections for electrical contact with at least one lead wire, wherein a plurality of wire guides extend vertically from the wire positioning plate, each wire guide having at least one guide path for supporting wire portions of the at least one lead wire over the wire positioning plate wherein the guide paths are vertically arranged relative to the wire positioning plate such that an overlapping wire portion is vertically spaced from a corresponding supported wire portion.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is an exploded view of a pump with an electric motor according to the present disclosure;

FIG. 2 is an exploded view of a stator assembly of the pump of FIG. 1;

FIG. 3 is an isometric view from the top of a wire connection plate of the stator assembly of FIG. 2;

FIG. 4 is an isometric view from the bottom of a wire connection plate of the stator assembly of FIG. 2;

FIG. 5 is a isometric view from the top of a stator assembly with the lead wire disposed on the wire connection plate;

FIG. 6 is a side view of a stator assembly with the lead wire disposed on the wire connection plate; and

FIG. 6A is an expanded view of a portion of the stator assembly of FIG. 6.

### DETAILED DESCRIPTION OF THE DRAWINGS

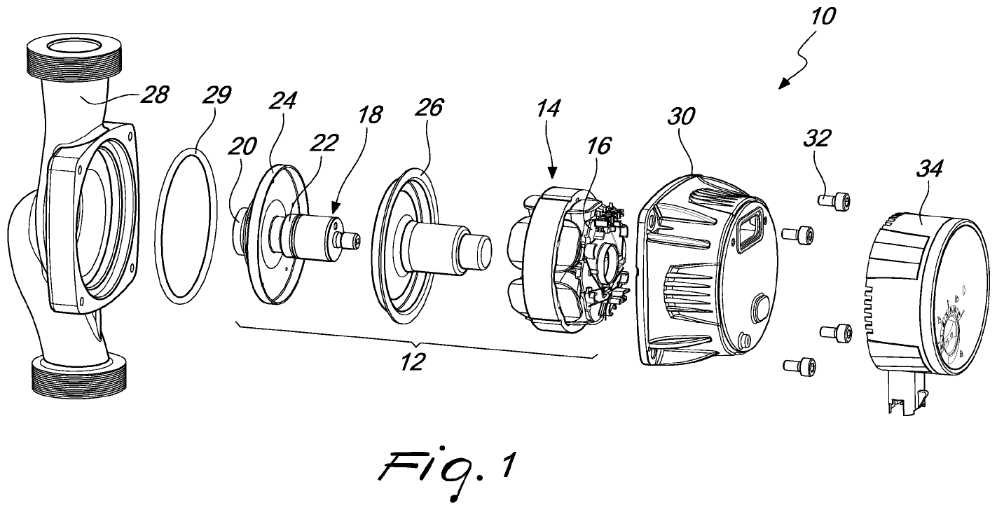

This disclosure generally relates to a pump having a separation of wires or a separation of portions of wires so as to avoid insulation problems. FIG. 1 illustrates a pump 10. Pump 10 has an electric motor 12 having a stator assembly 14. The stator assembly 14 has a wire positioning plate 16. Electric motor 12 further comprises a rotor assembly 18 and an impeller 20. The rotor assembly 18 and the impeller 20 are disposed in a rotor can 26.

Electric motor 12 may further comprises a thrust bearing assembly 22 and a bearing plate assembly 24. The thrust bearing assembly 22 and the bearing plate assembly 24 may be positioned between the rotor assembly 18 and the impeller 20.

The electric motor 12 is contained between a pump housing 28 and a motor housing 30. The motor housing 30 is mounted to the pump housing 28 by screws 32. An O-ring 29 is disposed between the rotor can 26 and the pump housing 28. A control box assembly 34 is positioned over the motor housing 30.

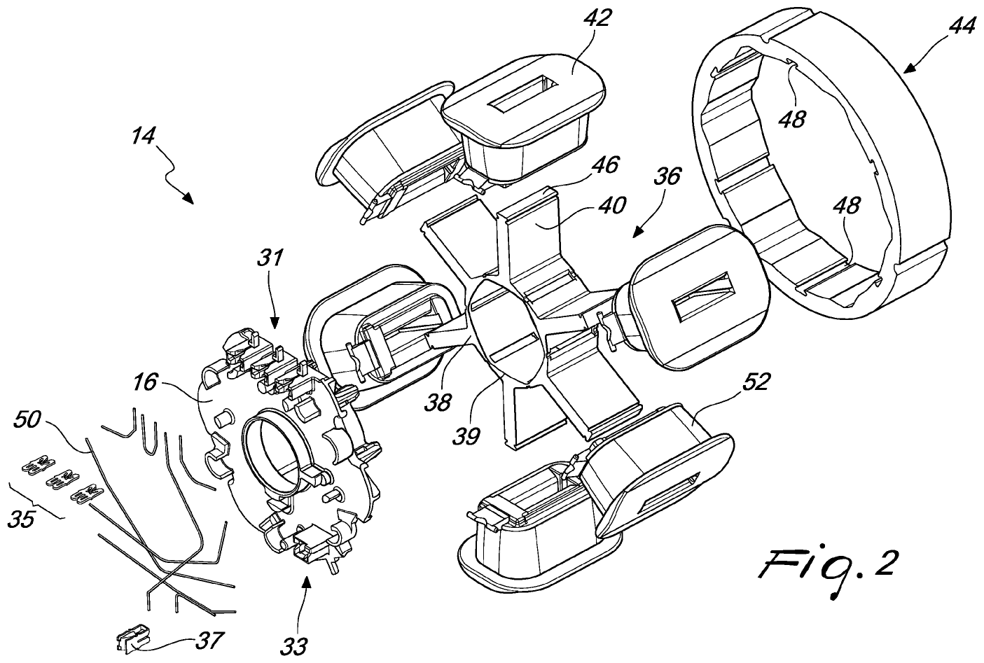

FIG. 2 illustrates the stator assembly 14 in an exploded view. The stator assembly 14 comprises of a stator body star 36. Stator body star 36 has a core 38 and a plurality of arms 40. The plurality of arms poles 40 radially extend from the core 38. Core 38 has a through opening 39. Opening 39 is configured to receive the rotor can 26. The stator body 36 is fixed relative to the rotor can 26. The rotor can 26 is configured to extend through the core 38 and to project beyond the stator body star 36.

A plurality of winding carriers 42 are supported on the arms poles 40. A stator ring 44 is configured to be connected to the stator body star 36. Arms poles 40 are configured to connect to the stator ring 44 through a press fit engagement. Terminal ends 46 of each arm are configured to be connected to corresponding grooves 48 in the inner side of the stator ring 44. Each winding carrier 42 is held on the respective arm poles 40 by the mounting of the stator ring 44 to the stator body 36. The winding carriers 42 are radially positioned about the wire positioning plate 16.

The winding carriers 42 may carry at least one lead wire 50. In an embodiment, the winding carriers 42 carries two lead wires 50. In a further embodiment, the winding carriers 42 carries three lead wires 50. The wire positioning plate 16 maintains the separation of different portions of the at least one lead wire 50. In an embodiment, the wire positioning plate 16 maintains the separation of different the lead wires 50. In a further embodiment, the wire positioning plate 16 maintains the separation of different portions of the lead wire 50 and maintains the separation of different the lead wires 50. The wire positioning plate 16 maintains an air gap between the portions of the at least one lead wire 50 and/or maintains an air gap between the different the lead wires 50. The at least one lead wire 50 may be formed as a plurality of windings 52 on the winding carriers 42. The at least one lead wire 50 extends from the plurality of windings 52. In an embodiment, a plurality of lead wires 50 are formed as in separate windings 52 on the respective winding carriers 42.

The wire positioning plate 16 supports electrical connections 31, 33. Electrical connections 31, 33 are provided for electrical contact with at least one lead wire 50 or a plurality of lead wires 50 provided in the stator assembly 14. Electrical connections 31 may comprise power pins 35. Electrical connections 31 enables electricity to flow into the stator assembly 14. Electricity flows from the power pins 35 to the at least one lead wire 50 or the plurality of lead wires 50. Electrical connection 33 may comprise a star connection such as a star connection pin 37. Electrical connection 33 enables electricity to flow out from the stator assembly 14. Electricity flows from the at least one lead wire 50 or the plurality of lead wires 50 to star connection pin 37.

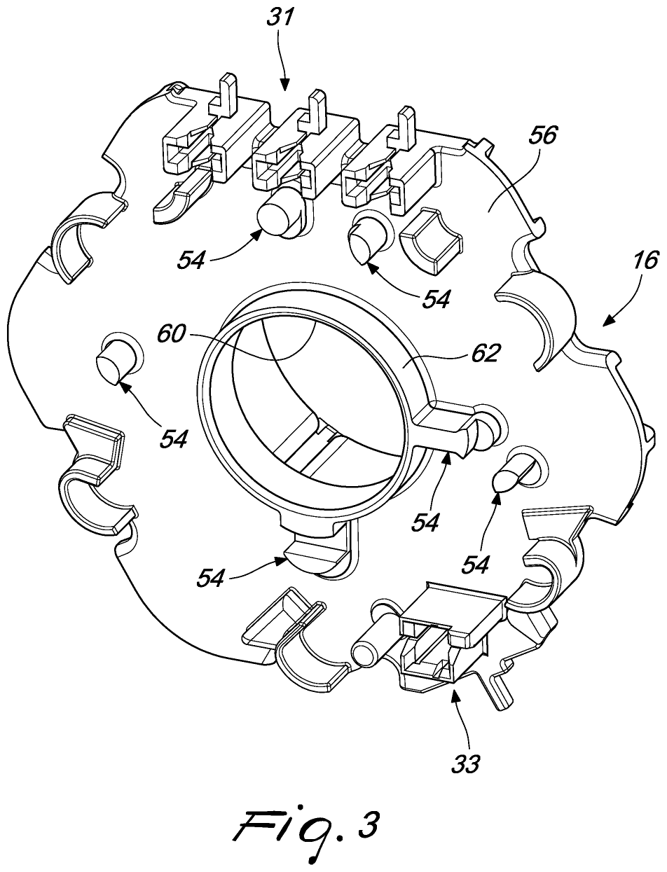

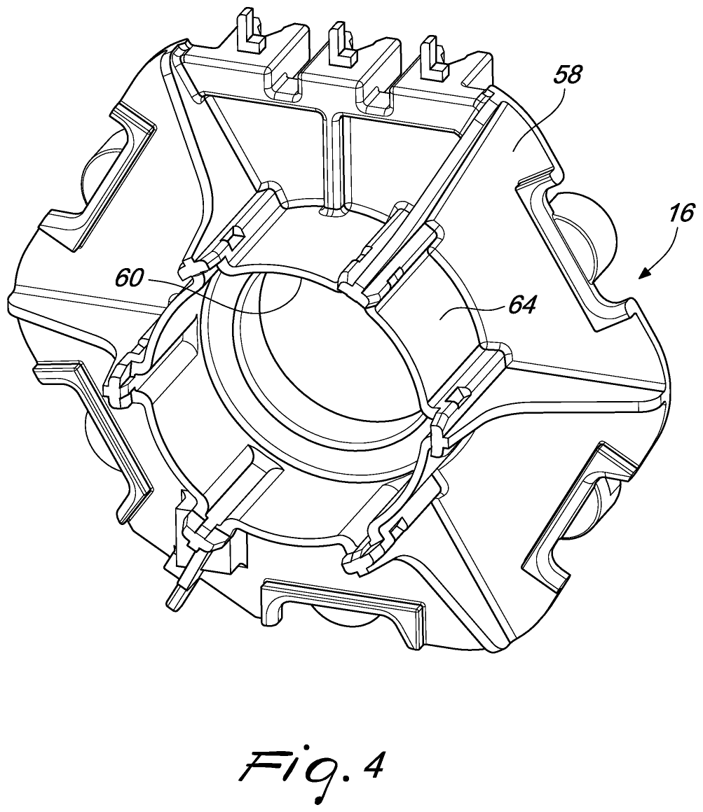

FIGS. 3 and 4 illustrate the wire positioning plate 16. Wire positioning plate 16 is composed of non-conducting material. Wire positioning plate 16 has a proximate surface 58 and a distal surface 56. The distal surface 56 may face away from the stator body 36 and the proximate surface 58 may face the stator body star 36.

A central aperture 60 extends between the proximate surface 58 and the distal surface 56. Central aperture 60 may extend beyond the proximate surface 58 and the distal surface 56. The central aperture 60 may be bound by a distal side wall 62 on the distal surface 56. The central aperture 60 may be bound by a proximate side wall 64 on the proximate surface 58. Central aperture 60 may have the same diameter as the through opening 39 of the stator core 38. Distal side wall 62 may be concentric with the proximate side wall 64. Electrical connections 31, 33 extend from the distal surface 56 of the wire positioning plate 16.

Wire positing plate 16 is held in position in the stator assembly 14 through the central aperture 60 and the axially extending projections 61. The central aperture 60 enables passage of a portion of the rotor can 26. Wire positing plate 16 is disposed on the rotor can 26 so as to be retained in a fixed position relative to the stator body star 36.

The wire positioning plate 16 comprise a plurality of wire guides 54. The plurality of wire guides 54 are disposed on the surface of the wire positioning plate 16. The plurality of wire guides 54 may be disposed on the distal surface 56 of the wire positioning plate 16. The plurality of wire guides 54 extend vertically from the wire positioning plate 16. Each wire guide 54 are composed of non-conducting material. Each wire guide 54 may be formed of a plastic material.

The plurality of wire guides 54 may be mutually spaced along the wire positioning plate 16. The plurality of wire guides 54 may be mutually horizontally spaced relative to the distal surface 56. The plurality of wire guides 54 may be disposed around the central aperture 60. The plurality of wire guides 54 may be disposed around the distal side wall 62. The spacing between the wired guides 54 may be configured such that any potential damage to a single wire guide 54 is compensated by adjacent wire guides 54.

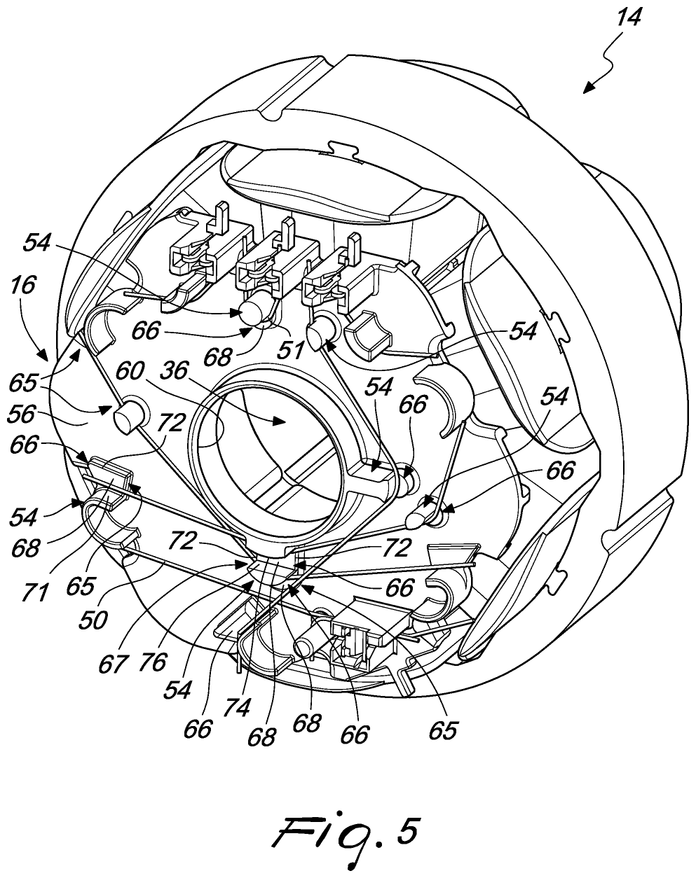

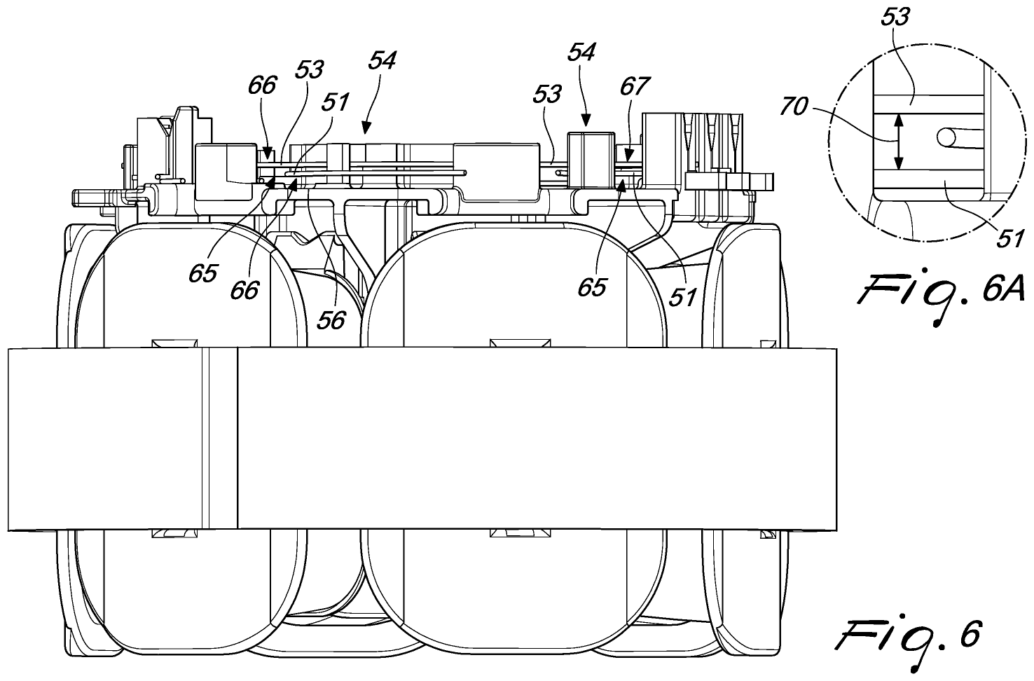

FIGS. 5 and 6 illustrate a wire positioning plate 16 positioned adjacent the stator body star 36. Wire positioning plate 16 is axially positioned relative to the stator body 36. At least one lead wire 50 is fixed to the wire positioned plate 16. Each wire guide 54 has at least one guide path 66 for supporting wire portions 51 of the at least one lead wire 50 over the wire positioning plate 16. Supported wire portions 51 of the at least one lead wire 50 are vertically spaced relative to the wire positioning plate 16 by respective wire guides 54. The supported wire portions 51 of the at least one lead wire 50 are vertically spaced from the distal surface 56 of the wire positioning plate 16.

With reference to FIG. 6, the guide paths 66 are vertically arranged relative to the wire positioning plate 16 so that an overlapping wire portion 53 is mutually vertically spaced from a corresponding supported wire portion 51. An overlapping wire portion 53 is a portion of the at least one lead wire 50 that extends over a supported wire portion 51. In an embodiment, the supported wire portion 51 and the overlapping wire portion 53 are of different lead wires 50.

With reference to FIG. 6A, an air gap 70 is present between the overlapping wire portion 53 and the corresponding wire portion 51 as a result of the vertical positioning of the respective wire portions 51, 53. Each guide path 66 is vertically spaced from the distal surface 56. The guide paths 66 may have different vertical spacing from the distal surface 56 in order to provide the required vertical positioning of the respective wires portions 51, 53. The specific vertical spacing for each guide path 66 may be provided as required for fixing of the at least one wire 50.

With reference to FIG. 5, each guide path 66 comprises a guide surface 68. The wire portions are supported on the respective surfaces 68. Each guide surface 68 is vertically spaced from the distal surface 56. The guide surfaces 68 may have different vertical spacing from the distal surface 56 in order to provide the required vertical positioning of the respective wires portions 51, 53. The specific vertical spacing for each guide surface 68 may be provided as required for fixing of the at least one lead wire 50.

The guide surface 68 is planar and defines the plane of the guide path 66. Each guide surface 68 may be substantially perpendicular to the respective wire guide 54. Each guide surface 68 may be parallel to the distal surface 56.

In an embodiment, the guide paths 66 extend laterally from the respective wire guides 54. The guide surfaces 68 extend laterally from the respective wire guide 54. Guide surfaces 68 are bound by a portion of the wire guide 54. Guide surfaces 68 are bound by an upright wall 71 along a lateral edge. Guide surfaces 68 have a free edge 72 extending from the upright wall 71.

In an embodiment, the guide paths 66 extend through the respective wire guides 54. Guide surfaces 68 are formed as cut-outs of the respective wire guides 54. Guide surfaces 68 are bound by a first upright wall 74 along a lateral edge and a second upright wall 76. Guide surfaces 68 have free edges 72 extending between the first upright wall 74 and a second upright wall 76.

With reference to FIGS. 5, 6 and 6A, the plurality of wire guides 54 may be arranged to enable the vertical spacing for respective overlapping wire portions 53 to pass over corresponding supported wire portions 51. The plurality of wire guides 54 may be arranged into arrays. The arrays may be configured in accordance with the required passage of the at least one lead wire 50. The guide paths 66 in each respective array have the same vertical spacing from the wire plate 16. The surfaces 68 in each array have the same vertical spacing from the distal surface 56.

In an embodiment, the plurality of wire guides 54 comprise at least a first guide array 65 and a second guide array 67. The guide paths 66 of first guide array 65 are vertically spaced relative to the guide paths 66 of the second guide array 67. The surfaces 68 of the guide paths 66 of first guide array 65 are vertically spaced relative to the guide surfaces 68 guide paths 66 of the second guide array 67. Guide paths 66 and the respective guide surfaces 68 of the first guide array 65 are uniformly vertically spaced relative to the guide paths 66 of the second guide array 67 and the respective guide surfaces 68 of the second guide array 67. The plane of the guide surfaces 68 of the first guide array 65 is vertically spaced relative to the plane of the guide surfaces 68 of the second guide array 67. The plurality of wire guide 54 may be arranged into further number of arrays as required relative to the number of overlapping segments.

In an embodiment, the wire positioning plate 16 supports a plurality of lead wires 50. The plurality wire guides 54 are configured for supporting portions of the plurality of lead wires 50 over the wire positioning plate 16. Each wire guide 54 has a guide path 66 for supporting portions of the plurality of lead wires 50 over the wire positioning plate 16.

The plurality of wire guides 54 comprise at least a first guide array 65 for supporting a first lead wire 50 and a second guide array 67 for supporting a second lead wire 50 wherein the guide paths 66 are vertically disposed such that an overlapping wire portion 53 of the first lead wire 50 is vertically spaced from a corresponding supported wire portion 51 of the second lead wire 50.

The guide paths 66 of first guide array 65 are vertically spaced at a greater height from the wire positioning plate 16 relative to the guide paths 66 of the second guide array 67. The guide surfaces 68 of the guide paths 66 of first guide array 65 are vertically spaced at a greater height from the wire positioning plate 16 relative to the guide surfaces 68 guide paths 66 of the second guide array 67. Guide paths 66 and the respective guide surfaces 68 of the first guide array 65 are uniformly vertically spaced at a greater height from the wire positioning plate 16 relative to the guide paths of the guide paths 66 and the respective guide surfaces 68 of the second guide array 67. The plane of the guide surfaces 68 of the first guide array 65 is vertically spaced at a greater height from the wire positioning plate 16 relative to the plane of the guide surfaces 68 of the second guide array 65.

The skilled person would appreciate that foregoing embodiments may be modified or combined to obtain the pump 10 of the present disclosure.

### INDUSTRIAL APPLICABILITY

This disclosure describes a pump 10 having a wire connection plate 16. The wire connection plate 16 has wire guides 54 for supporting portions of a lead wire 50 or portions of a plurality of lead wires 50. The wire guides 54 prevent contact of overlapping portions 51, 53 of a lead wire 50 or of overlapping portions 51, 53 of a plurality of lead wires 50. The wire guides 54 support the overlapping portions 51, 53 in a vertical arrangement so as to vertically separate the overlapping portions 51, 53. The wire guides 54 support overlapping portions 51, 53 in differing vertical distances. The wire guides 54 define the wire paths 66 having path planes that are configured to ensure that there is no contact zone between the overlapping portions 51, 53 of a wire 50 or overlapping portions 51, 53 of a plurality of wires 50 to prevent a short circuit and increase the insulation level. The production costs of the wire plate 16 is reduced as it is made from plastics.

The wire plate 16 provides an increased reliability in case of damage to a wire guide 54 as the horizontal distance between guided wires is determined so as to offset damage in respect to adjacent wire guide 54.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof. The foregoing embodiments are therefore to be considered in all respects illustrative rather than limiting of the disclosure described herein. Scope of the disclosure is thus indicated by the appended claims, rather than the foregoing description, and all changes that come within the meaning and range of equivalence of the claims are therefore intended to be embraced therein.

1. A pump comprising:
an electric motor having a stator assembly, the stator assembly comprising:
a wire positioning plate supporting electrical connections for electrical contact with at least one lead wire,
wherein a plurality of wire guides extend vertically from the wire positioning plate, each wire guide having at least one guide path for supporting wire portions of the at least one lead wire over the wire positioning plate,
wherein the guide paths comprise respective planar surfaces and extend laterally from the respective wire guides, the planar surfaces extending laterally from the respective wire guides and
wherein the guide paths are vertically arranged relative to the wire positioning plate such that an overlapping wire portion is vertically spaced from a corresponding supported wire portion.

2. The pump of claim 1 wherein the plurality of wire guides comprise at least a first guide array and a second guide array wherein the guide paths of first guide array are vertically spaced relative to the guide paths of the second guide array.

3. The pump of claim 1 wherein the wire positioning plate supports a plurality of lead wires wherein the plurality wire guides are configured for supporting portions of the plurality of lead wires over the wire positioning plate.

4. The pump of claim 3 wherein the plurality of wire guides comprise at least a first guide array for supporting a first lead wire and a second guide array for supporting a second lead wire wherein the guide paths are vertically disposed such that an overlapping wire portion of the first lead wire is vertically spaced from a corresponding supported wire portion of the second lead wire.

5. The pump of claim 2 wherein the guide paths of first guide array are vertically spaced at a greater height from the wire positioning plate relative to the guide paths of the second guide array.

6. The pump of claim 1 wherein the guide paths extend through the respective wire guides.

7. The pump of claim 6 wherein the planar surfaces are formed as cut-outs of the respective wire guides.

8. The pump of claim 1 wherein the wire positioning plate has a central aperture for passage of a rotor can.

9. The pump of claim 1 wherein the stator assembly further comprises a stator body star having a core and a plurality of radially extending arms poles wherein the wire positioning plate is axially positioned relative to the stator body star.

10. The pump of claim 1 wherein the stator assembly further comprises a plurality of winding carriers radially positioned about the wire positioning plate wherein the at least one lead wire extends from the winding carriers to the wire positioning plate.

11. The pump of claim 1 wherein the wire positioning plate is composed of non-conducting material.
